(19) United States
(12) Patent Application Publication
(10) Pub. No.: US 2017/0122494 A1
(43) Pub. Date: May 4, 2017

(54) Tank for under pressure-fluids, for example methane, as well as method of assembling the same

(71) Applicant: Simone Illesi, Sarcedo (Vicenza) (IT)

(72) Inventor: Simone Illesi, Sarcedo (Vicenza) (IT)

(21) Appl. No.: 15/301,808

(22) PCT Filed: Mar. 18, 2015
(86) PCT No.: PCT/IB2015/051996

§ 371 Date: Oct. 4, 2016

(30) Foreign Application Priority Data
Apr. 4, 2014 (IT) VR2014A000087

(51) Int. Cl. F17C 1/06; F17C 1/16

(52) U.S. Cl. CPC F17C 1/06; F17C 1/16; F17C 2201/0119; F17C 2201/0128; F17C 2201/0157; F17C 2203/013; F17C 2203/0607; F17C 2203/0619; F17C 2203/0617; F17C 2203/066; F17C 2203/0663; F17C 2209/22; F17C 2209/2154; F17C 2221/033; F17C 2260/011; F17C 2270/0168

(57) ABSTRACT

The present invention regards a tank for containing a pressurized fluid including at least one shell component provided with a surface that is external during use and with a surface that is internal during use, as well as at least two framework components, the shell component delimiting at least two positioning seats or slits of the framework components.

### TECHNICAL FIELD OF THE INVENTION

The present invention regards a tank for containing a pressurized fluid, for example methane or another combustible fluid; which tank can for example be housed in a suitable compartment of a vehicle.

### STATE OF THE PRIOR ART

Many tanks for containing methane have been proposed, made of different materials as well as comprising one or more layers.

The international application No. PCT/IB2007/000691 for example teaches a tank for pressurized fluids which has two layers, an internal layer or metal liner and a composite material layer wound around the internal layer. The tank can also comprise several stiffening components, such as tie rods that are extended within the tank from one side to the other thereof in contact with the fluid, or components that are welded inside the internal layer.

Such solutions, if on one hand they ensure good resistance of the tank to the pressures of the fluid housed therein, on the other hand involve manufacturing and mainly assembling steps that require time as well as attention and experience for the obtainment thereof, such as welding or insertion and screwing of the tie rods.

Moreover, the tie rods determine a localized support and stiffening, thus determining a localized and undesired distribution of the forces in the tank.

DE102012223676A1D2, DE102008033874A1 and GB 499366A illustrate respective tanks according to the state of the art.

### SUMMARY OF THE INVENTION

One object of the present invention is to provide a new tank for containing fluids.

Another object of the present invention is to provide a tank for containing fluids that is stronger than the tanks proposed up to now.

Another object of the present invention is to provide a tank that is simple and quick to obtain and assemble.

Another object of the present invention is to provide a tank having a new configuration that allows an optimization of the available space.

Another object of the present invention is to provide a tank in which the fluid housing zone is well-isolated.

Another object of the present invention is to provide a new method for assembling a tank.

In accordance with one aspect of the invention, a tank is provided according to the present principles.

In accordance with one aspect of the invention, a method is provided for assembling a tank according to the present principles.

The dependent claims refer to preferred and advantageous embodiments of the invention.

### BRIEF DESCRIPTION OF THE DRAWINGS

Other characteristics and advantages of the present invention will be clearer from the description of embodiments of a tank, illustrated by way of example in the enclosed drawings, in which:

FIG. 1 is a perspective view slightly from above of a tank according to the present invention lacking external cover layer;

FIG. 2 is a section view of a tank as that of FIG. 1 provided with an external cover layer;

FIG. 3 is an exploded view of the tank of FIG. 2;

FIG. 4 is a perspective view slightly from above of another tank embodiment according to the present invention;

FIG. 5 is a section view of the tank of FIG. 4;

FIG. 6 is a section view of the tank of FIG. 4 lacking external cover layer;

FIG. 7 is an exploded view of the tank of FIG. 4;

FIG. 8 is a perspective view slightly from above of another tank embodiment according to the present invention;

FIG. 9 illustrates the framework and reinforcement structure of the tank of FIG. 8;

FIG. 10 illustrates a step for obtaining the tank of FIG. 8;

FIG. 11 illustrates a step for obtaining another tank according to the present invention; and

FIG. 12 is a section view of the framework and reinforcement structure of the tank of FIG. 11.

In the enclosed drawings, equivalent parts or components were marked with the same reference numbers.

### DETAILED DESCRIPTION OF THE INVENTION

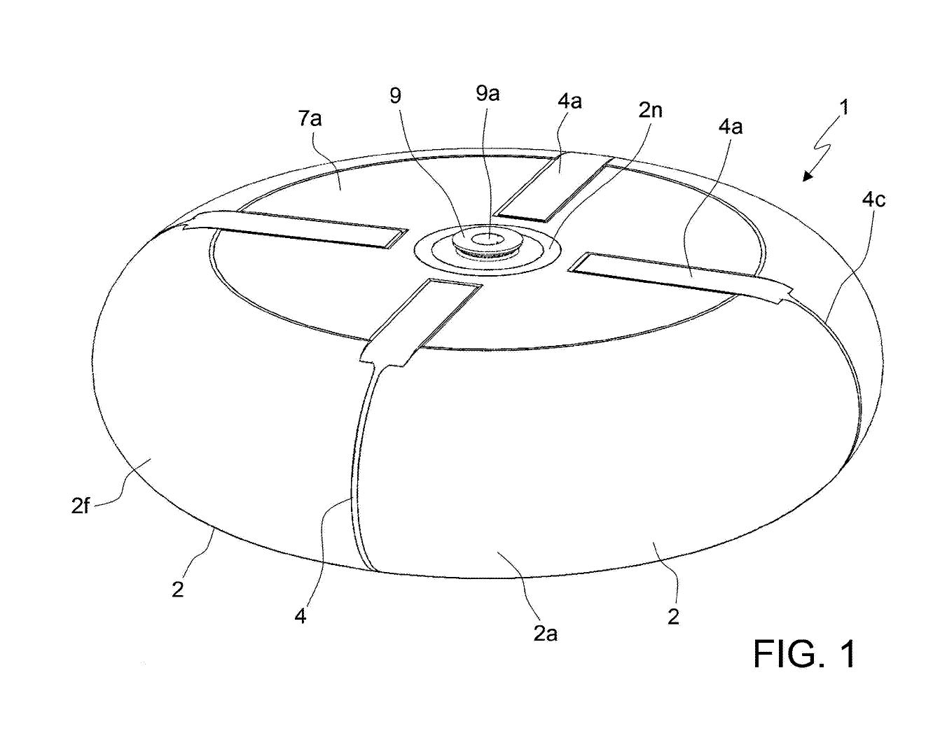

With reference to FIGS. 1 to 3, a tank 1 according to the present invention is shown for containing a pressurized fluid, such as gas, e.g. methane, which comprises at least one shell component 2, preferably made of a single piece, e.g. obtained via molding, which is provided with a surface 2a, external during use, and with a surface 2b, internal during use.

A tank according to the present invention is intended in particular for containing pressurized fluids, such as gases, if desired at high or very high pressure.

The internal surface 2b of the shell component delimits one or more fluid housing zones 3, even if, as will be understood, the tank could comprise an inner cover layer of the surface 2b.

Preferably, the shell component 2 is made of a material with fluid seal, if desired of a plastic or composite material, so as to prevent the passage of the fluid through walls thereof, and to allow such passage only through suitable holes or openings that are for example provided (as will also be stated hereinbelow) in sleeve or bushing elements assembled therewith.

Preferably, the shell component 2 delimits the entire housing zone 3 of the fluid, if desired, as will be stated hereinbelow, with a part or portion of sleeve or bushing elements assembled therewith.

Still more preferably, different shell components are not provided that are assembled together for the definition or delimiting of the housing zone, even if the shell component could be formed by two or more half-shells assembled together and fixed, e.g. welded.

The tank 1 then comprises two or more framework components, four according to the embodiment illustrated in the figures, for example framework beam or plate components 4, preferably made of composite material, if desired of another material, such as a metal, and in addition the tank delimits one or more sections for the engagement and insertion 5, preferably slidably, of or in a respective connection portion of each plate component 4, such that each framework component is extended transversally or intercepting the housing zone 3. More particularly, the engagement and insertion section/sections 5 is/are intended to allow the guided positioning or guided insertion in position of a respective framework component 4 transversally or intercepting the fluid housing zone 3.

As it will be understood, an engagement and insertion section can comprise both a respective seat, hollow portion or recessed portion intended to receive, if desired slidably, a respective connection portion of a plate component, and a protruding portion or protrusion intended to be inserted, if desired slidably, in a channel or slot portion of a plate component.

Advantageously, an engagement and insertion section or sections 5 comprises/comprise at least one positioning seat or slit 5a delimited by the shell component 2 for a respective part of a respective framework component 4, such seat intercepting or extending through the housing zone 3. Still more advantageously, one or each positioning seat 5a is fluidly sealed with respect to the housing zone 3, such that one or each plate component 4, when positioned in the respective positioning seat 5a, is not in contact with the pressurized fluid within the tank 1.

Regarding the feature according to which the plate components 4 are extended transversally or intercepting the housing zone 3, it is to be intended that such components or the respective housing seats project within the housing zone such that they or the respective positioning seats or slits 5a divide or separate the zone 3 into sectors 3a, if desired in fluid communication, e.g. at the center of the tank. According to the embodiment shown in figures, four plate components are provided, delimiting four sectors 3a of the housing zone in fluid communication at the center of the housing zone, due to the fact that the plate components 4 or better yet the respective positioning seats 5a do not extend and do not join at the center of the tank, even if, according to a variant of the present invention, this is possible.

The insertion and engagement sections, as will also be stated hereinbelow, are preferably accessible and engageable by means of a respective connection portion of a plate component 4 starting from the exterior of the shell component. More particularly, one or more insertion and engagement sections are open towards the outside of the shell component.

The tank comprises at least two positioning seats or slits 5a, angularly spaced or offset, if desired equally spaced apart, for example substantially aligned, and at least two framework components 4 each housed in one of such positioning seats 5a. According to the embodiment in the figures, four positioning seats 5a are provided, aligned two-by-two and angularly spaced by about 90°.

Each positioning seat or slit 5a can be delimited by a pair of walls 5a1 substantially parallel to each other and protruding, if desired from the top to the bottom of the shell component 2 and starting from the external edge to nearly the center of the shell component 2, as stated above. In addition, the walls 5a1 are preferably integrally obtained with the other walls of the shell component 2 or connected with fluid seal therewith. The walls 5a1 are connected within the shell component 2 by means of a bridge connection section 5a2, also preferably extended from the top to the bottom of the shell component 2 and integrally formed or connected with fluid seal both with the walls 5a1 and with the other components of the shell component 2.

Preferably, a respective connection portion 4a, 4b, 4c of the plate component 4 is inserted to size in a respective engagement and insertion section 5, so as to shape engage therewith. For such purpose, one or more of the plate components 4 comprises a main wall 4c, if desired flat, which during use is extended transversally or intercepting the housing zone 3, as well as at least one end wall or section 4a, 4b extended transversally (e.g. at 90°) with respect to the main wall 4c and intended to slidably engage a respective engagement and insertion section 5.

Preferably, one or more plate components 4 comprise one or two end walls 4a, 4b extending one 4a starting from one edge, if desired the top and the other 4b from the other edge, if desired the bottom of the main wall 4c of the plate component 4, while the other front or internal 4e and rear or external 4f edges of the plate component 4 can be substantially free. The rear or external edge 4f could be substantially shaped as the edge of the shell component so as to be flush or aligned therewith when the respective plate component 4 is within a positioning seat or slit 5a.

With one such structure, a plate component 4 would comprise a plate or beam with upper and/or lower end substantially T-shaped.

Advantageously, one or more of the plate components 4 is arranged with main wall 4c with substantially vertical trim, i.e. in upright and self-supporting position, while the end wall(s) 4a, 4b are arranged with substantially horizontal position, so as to have an end wall that constitutes a base or foot of the respective plate component 4, if desired the lower end wall 4b. Due to such structure, the plate or beam component 4 stiffens or reinforces the respective tank without however stressing the bending of other components thereof, in particular the shell component 2.

In addition, each plate component 4 can be symmetrical around a plane parallel to the front 4e—rear 4f direction and passing through the center line thereof, such that it can be arranged with either 4a or the other 4b end wall as the lower end wall.

One or both the end walls 4a, 4b could also be configured in a different manner, for example wider or longer so as to engage or affect a greater surface area of the shell component and, if desired, also being extended until it is engaged, during use, with an end wall of another beam component 4. In such case, during use, each beam component 4 could have one end connected, e.g. by means of shape engage, with one end of another beam component 4.

The tank then preferably comprises one or more, two according to the embodiment illustrated in the figures, reinforcement plates or sheets 7a, 7b, i.e. a rigid mechanical constraint, for connecting the framework components 4 or respective ends of two or more framework components 4; if desired, such reinforcement plates 7a, 7b are intended to be arranged resting on or in abutment against a respective main wall, if desired substantially flat or slightly curved 2d, 2e of the shell component 2. According to the embodiment illustrated in the figures, the shell component 2 has an upper wall 2d and a lower wall 2e, if desired, substantially flat and substantially parallel or slightly curved, which are connected by means of an edge, if desired rounded or convex 2f and two reinforcement plates 7a, 7b are then provided, during use each externally brought in abutment an against a respective wall, respectively upper 2d or lower 2e wall.

Preferably, the end walls 4a, 4b are during use extended with position substantially parallel to a respective flat wall 2d or 2e.

The flat wall 2d or 2e can be undercut with respect to the respective end 2f1 of the convex or rounded edge 2f, such that a step or undercut section 2g is provided therebetween. In such case, the flat wall 2d or 2e and the respective undercut section 2g delimit an impression 10 for positioning a respective plate 7a or 7b. The impression 10 can be suitably shaped, for example with lowered or raised sections, so as to shape engaged with a respective reinforcement plate 7a, 7b.

In addition, the shell component 2 can comprise a section of tubular wall 2m with flanged end 2n protruding towards the tank exterior, from an internal or central end 2o of one or both flat walls 2d or 2e, as well as a cap or dome component protruding, always from an internal or central end 2o but in a direction opposite to that of the section 2m and towards the tank interior and comprising a substantially cylindrical wall section 2p as well as a closure or terminal wall 2q. Preferably, in the closure or terminal wall 2q, a through hole 2r is delimited, if desired situated at the center for grounds that will be delineated hereinbelow.

Preferably, the flanged end 2n of the tubular wall section 2m is substantially aligned with the respective end 2f1 of the convex or rounded edge 2f, such that the impression 10 for a respective flat wall 2d or 2e is delimited between the flat wall 2d or 2e, the respective undercut section 2g and the tubular wall section 2m.

One or more of the reinforcement plates 7a, 7b can delimit a hole or opening 7e, in which, when the tank is assembled, the tubular wall section 2m is housed.

If desired, one or more engagement and insertion sections can be formed or delimited in the reinforcement plate(s) 7a, 7b.

In such case, in one or both reinforcement plates 7a, 7b, one or more grooves 5b is formed which constitutes/constitute part of an insertion or engagement section of a connection portion of a plate component, e.g. a connector portion 4d between an end wall 4a, 4b and the main wall 4c, if desired slightly tapered towards the main wall 4c. The groove 5b is substantially aligned, during use, with a positioning seat 5a, while a respective plate component 4 is inserted in the positioning seat or slit 5a and in a respective groove 5b.

Advantageously, in the shell component 2, if desired in the flat wall 2d and/or 2e and, if desired, partly in the rounded or convex edge 2f, a protruding portion is provided or a hollow portion 5c is obtained for engaging or housing, if desired slidably, with a respective end wall 4a or 4b of a respective plate component 4. The protruding portion or hollow portion 5c can also shape engage with a respective end wall 4a or 4b. In such case, the protruding portion or hollow portion 5c constitutes a section for the engagement and insertion in the above-indicated sense. Preferably, two or more (four according to the embodiment illustrated in the figures) protruding portions or hollow portions 5c are provided that are angularly spaced from each other, e.g. by 90°. The protruding portion(s) or hollow portion(s) are preferably open towards the shell component exterior and can be engaged via insertion, if desired slidable, by a respective portion of a plate component starting from the shell component exterior.

If instead one or more reinforcement plates 7a, 7b are provided, then the latter can comprise one or more protrusions or recessed portions 5d for the engagement or housing, if desired with shape engagement, of a respective end wall 4a or 4b of a respective plate component 4. In such case, the recessed portion 5d constitutes a section for the engagement and insertion in the above-indicated sense for a respective connection portion of a plate component 4. Preferably, two or more (four according to the example illustrated in the figures) protrusions or recessed portions 5d are provided that are angularly spaced with respect to each other, for example by 90°. Each protrusion or recessed portion 5d can then in turn, if desired, be engageable with a respective protruding portion or housable in a respective hollow portion 5c of the shell component 2, e.g. with shape coupling.

In the present patent application, by shape coupling it is intended a coupling between two components having substantially complementary shapes, or in any case such to engaged in a stable manner due to their configuration. By insertion to size it is instead intended the insertion of a first component in a seat or slot of a second component substantially having the same size as the first component, such that in order to attain the insertion it is necessary to force, at least slightly, the relative motion between the first and the second component.

The main wall 4c of the plate component 4 is preferably slidably mounted within the respective positioning seat 5a, while the or each end wall 4a, 4b or better yet a connector portion 4d is slidably mounted in a respective groove 5a.

A plate component 4 could also be provided with a main wall configured differently and intended to remain, during use, outside the shell component 2, and with one or more end walls 4a, 4b inserted, if desired to size, in respective sections or portions 5c or 5d of the shell component 2 or of a reinforcement plate 7a, 7b. In such case, the main wall 4c could for example be configured substantially curved or in any case such to follow or substantially wrap around the external profile of the shell component 2, if desired an edge or edge wall thereof.

Advantageously, the main wall 4c of a plate component 4 has extension smaller than or substantially corresponding to the respective positioning seat 5a, and, still more advantageously, when a plate component 4 is arranged within a respective positioning seat 5a, the rear or external edge 4f is substantially flush or aligned with the edge 2f.

Preferably, in particular according to the embodiment illustrated in the figures, the shell component 2 is configured as a solid of rotation around an axis of symmetry x-x and the positioning seat(s) 5a are extended radially with respect to the shell component 2, i.e. the positioning seats or slits 5a converge towards the axis of symmetry x-x.

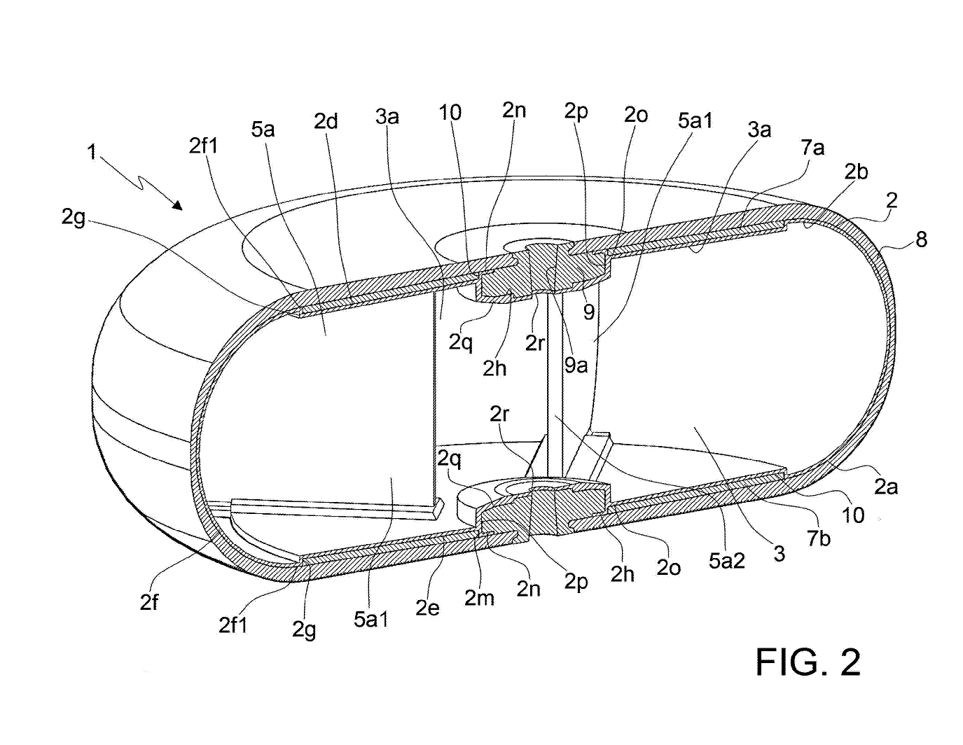

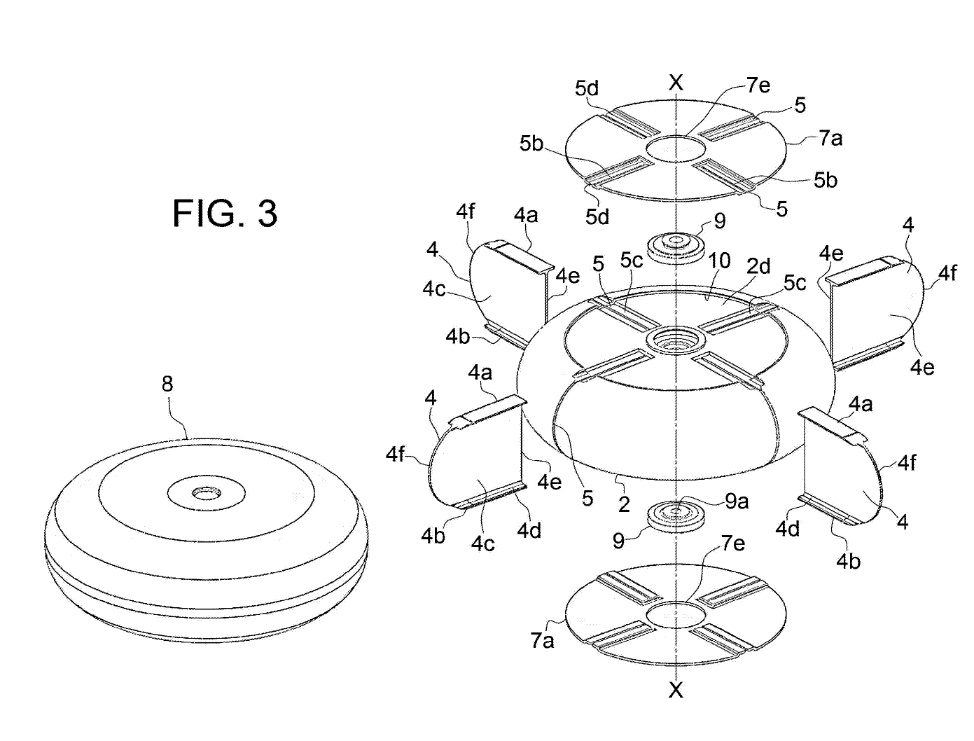

The tank 1 can also be provided with an external cover or coat layer 8 for the shell component 2 and the beam component(s) 4 (see in particular FIGS. 2 and 3), which if desired can for example be made of composite material, such as fibers, if desired carbon fibers that can be wound, in a known manner, around the shell component 2, plate components 4 and, if provided, around the reinforcement plate(s) 7a, 7b. The external cover or coat layer 8 can also be made in any other suitable manner

The tank 1 can also be provided with one or better yet a pair of sleeve or bushing elements 9, e.g. made of metal, such as aluminum, which are partially housed in a respective connection seat 2h delimited by the shell component 2, if desired between the shell component 2 and the external cover layer 8.

Each connection seat 2h can be formed in a substantially central or intermediate zone of a main wall 2d, 2e. If desired, a connection seat 2h can be delimited, if such components are provided, between a tubular wall section 2m, a flanged end 2n, a substantially cylindrical wall section 2p and by a closure or terminal wall 2q.

In a sleeve element or better yet in a through opening 9a, for example internally threaded, formed therein a suitable valve (not shown in the figure) can be positioned for delivering a pressurized fluid from a source to the containment zone 3, and for evacuating the pressurized fluid or air from such zone 3. If desired, the through opening 9a can be aligned and in fluid communication with a through hole 2r delimited in a respective closure or terminal part 2q.

According to such variant, the external cover layer 8 could be wound or arranged around all the elements of the container except for a section of the sleeve elements 9, so as to leave at least the opening 9a and hence the respective valve exposed.

As also stated above, the whole fluid housing zone 3 is preferably only delimited by the shell component 2 and by a part of the sleeve or bushing elements 9 assembled therewith or in a respective connection seat 2h.

For the assembly of a tank as described above, it is sufficient to arrange a shell component 2 and hence to arrange or obtain the framework components 4 in the positioning seats 5a. For such purpose, for example, the plate component(s) 4 are brought or inserted in position so as to engage respective connection portions thereof with or in the engagement and insertion sections of the tank, e.g. if provided an end wall 4a, 4b in a respective hollow portion 5c and/or a main wall 4c in a respective positioning seat 5a.

If reinforcement plates or sheets 7a, 7b are provided, then these can be brought into abutment, if desired against a respective flat wall 2d, 2e, e.g., if provided, in the impression 10, after which one proceeds to insert connection portions of the plate component(s) 4 in the engagement and insertion sections, e.g. an end wall 4a, 4b in a respective recessed portion 5d, a main wall 4c in a respective positioning seat 5a and/or a connector portion 4d in a respective groove 5b. The reinforcement plates 7a, 7b can if desired be made of composite material or of another material, such as metal.

Before such step, the sleeve or bushing elements 9 can be brought into work position, if desired in a respective connection seat 2h.

After such steps, the shell component 2 assembled with the plate component(s) 4 and, if desired, reinforcement sheets 7a, 7b can be covered by means of an external cover layer 8, for example applied by means of winding, if desired of fibers, around such assembled components.

As will be understood, one such tank is very strong and is also obtained by means of a sequence of steps that are very simple and quick to achieve, and in any case has high strength and rigidity, considering that it is provided with one or with a plurality of plate components 4 brought into position by means of easy insertion steps and which still engage and support the tank and the respective shell component for most of its extension.

In addition, preferably, the plate components 4, due to their configuration, are self-supporting and hence do not cause bending or stresses on the remaining components, in particular on the shell component.

In addition, as stated above, the engagement and insertion sections are preferably accessible and engageable by means of a respective portion of a plate component 4 starting from the shell component exterior; hence, it is possible to assemble and bring into position the plate components 4 by means of insertion of its connection portions in a section of the shell component or (if provided) of the plates, after the shell component has been obtained or in any case assembled to delimit the entire reception seat 3 of the pressurized fluid.

The plate components 4 are also extended for nearly the entire transverse extension of the tank, thus ensuring a good distribution of the forces in the tank itself, in particular if reinforcement plates 7a, 7b are also provided which are extended for nearly the entire width or respective main face of the shell component and connect the framework components.

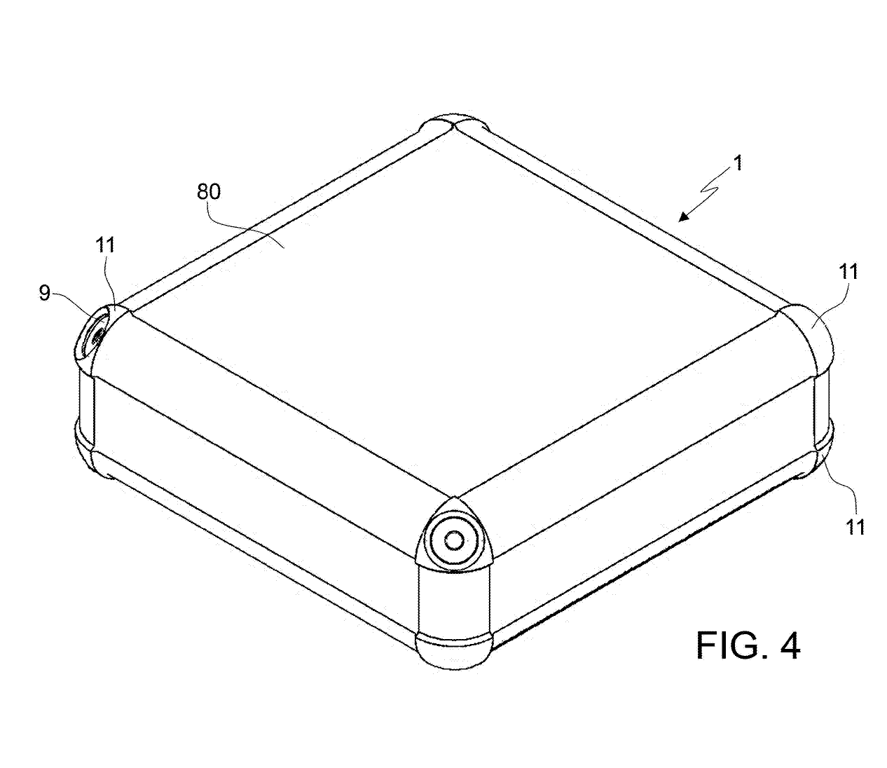

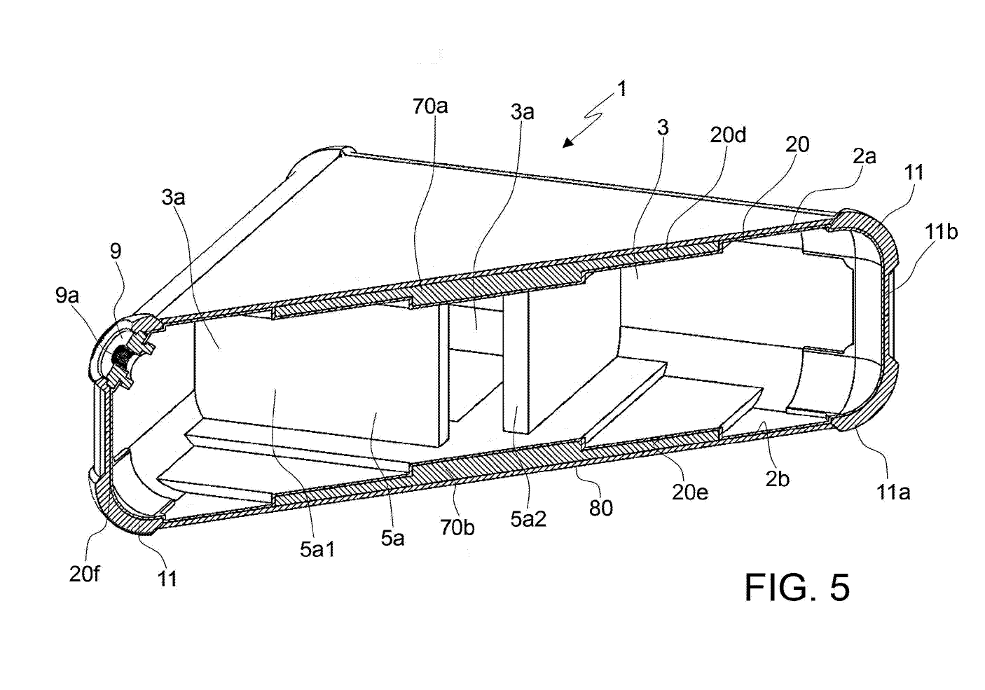

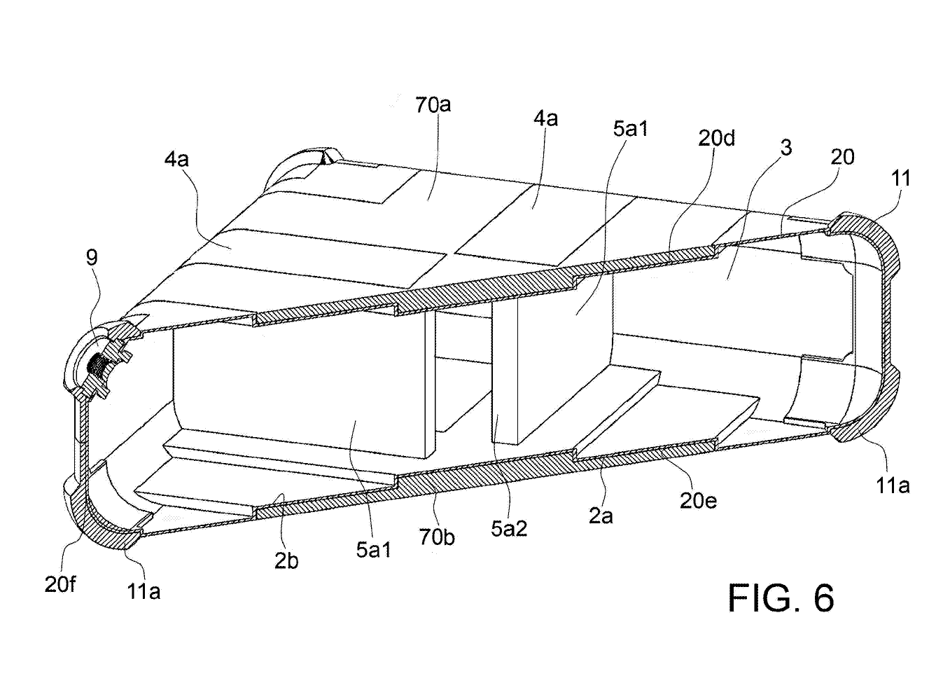

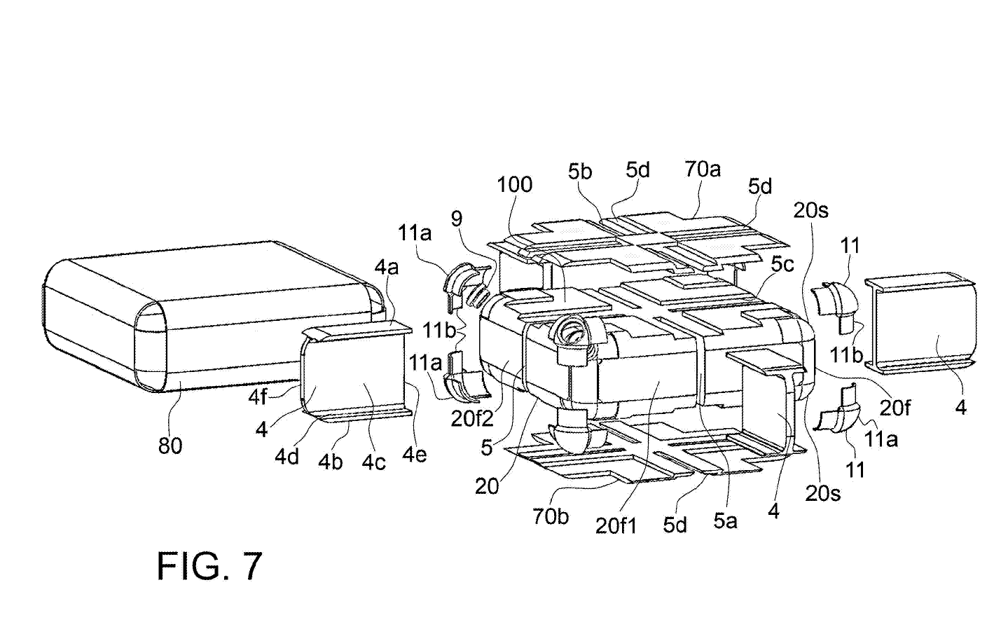

With reference now to FIGS. 4 to 7, another tank embodiment is illustrated that is similar to that described above, although the same comprises a shell component 20 substantially configured as a parallelepiped, if desired with rounded edges.

Such tank can thus comprise two substantially main faces, if desired flat 20d, 20e connected by means of an edge 20f comprising a plurality of angularly offset sides, e.g. four sides, two larger parallel sides 20f1 connected by means of two smaller parallel sides 20f2 or more equal sides, for example three, four or a plurality of sides. In the main faces 20d and 20e, impressions 100 can be formed or delimited for one or more plates 70a, 70b, entirely similar to the above-described plates 7a, 7b.

In each side or better yet starting from each side, if desired starting from a zone at the midpoint thereof, a respective positioning seat 5a for a respective plate component 4 can be extended towards the interior of the tank; such seat can be substantially parallel to one side 20f1 or 20f2 of the shell component 2 or the positioning seats or slits 5a converge towards a longitudinal axis of symmetry of the shell component 20.

However, unlike the tank illustrated in FIGS. 1 to 3, one or more protecting elements 11 can be provided at the corners 20s of the shell component 20.

The protecting elements 11 can for example comprise a substantially curved main intermediate section 11a intended to wrap or cover a respective corner 20s of the shell component 20, starting from which wing-shaped sections 11b are extended (three according to the embodiment in the figures), they too if desired curved and each intended to cover a section of a respective edge of the shell component converging towards the corner 20s.

The protecting elements 11 can be maintained in position, after the positioning on respective corners 20s, if desired, by means of winding the external cover layer 80 therearound, and in particular around the wing-shaped sections 11b.

According to such variant, the external cover layer 80 could be wound or arranged around all the elements of the container except for the substantially curved intermediate sections 11a.

In addition, the tank can comprise at least one perforated protecting element 11 delimiting, with the shell component 20, a seat for a sleeve element 9.

One such container can be substantially assembled as described with reference to the embodiment illustrated in FIGS. 1 to 3 and has the same structural advantages including simplicity and rapidity of assembly as described above.

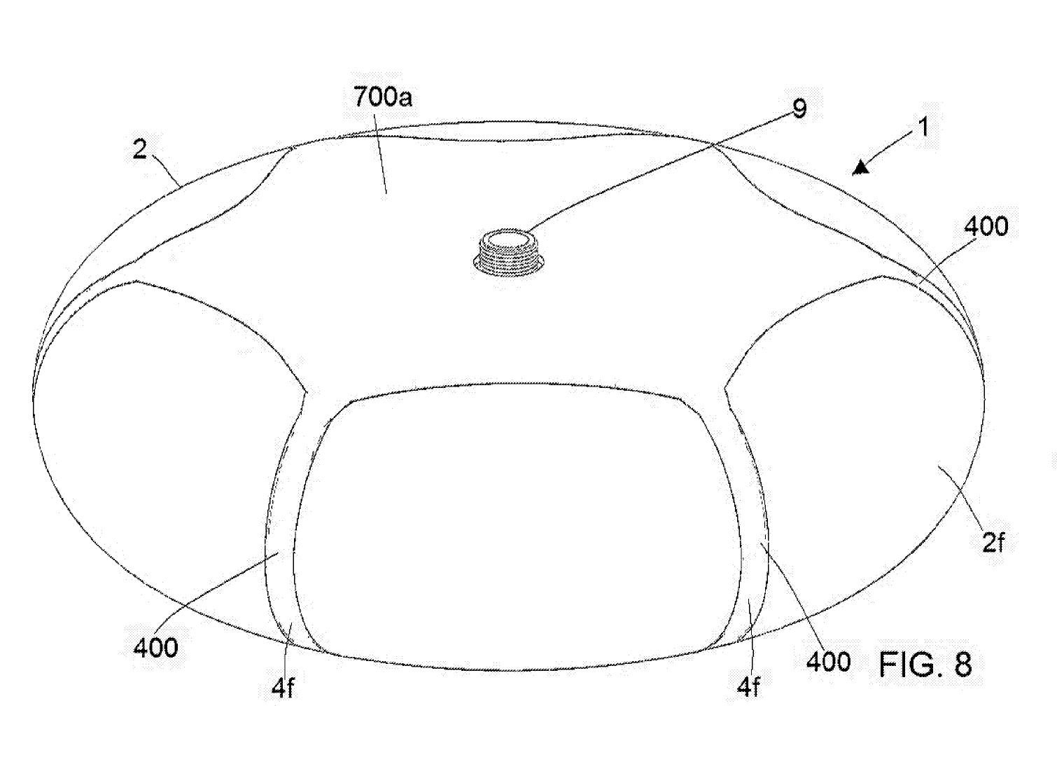

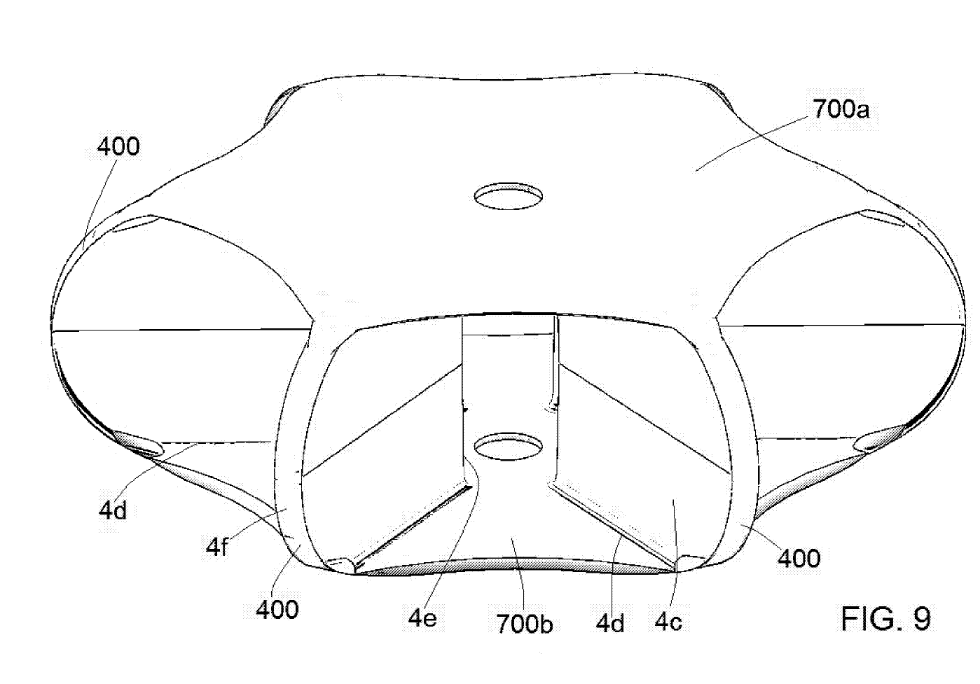

With reference now to FIGS. 8 to 10, another tank 1 according to the present invention is illustrated, similar to the tank illustrated in FIGS. 1 to 3, but in which the framework components, if desired beam components 400 and the reinforcement plate(s) 700a, 700b are substantially integral or made of a single piece, e.g. obtained by “filament winding” or winding of continuous filaments made of composite material, i.e. by means of winding continuous filaments on the shell component 2, 20. Therefore, even in such case, the framework components 400 and the reinforcement plates 700a, 700b are part of the same reinforcement and framework structure, in which the reinforcement plates 700a, 700b constitute a connection section, if desired top or bottom, of the framework components 400.

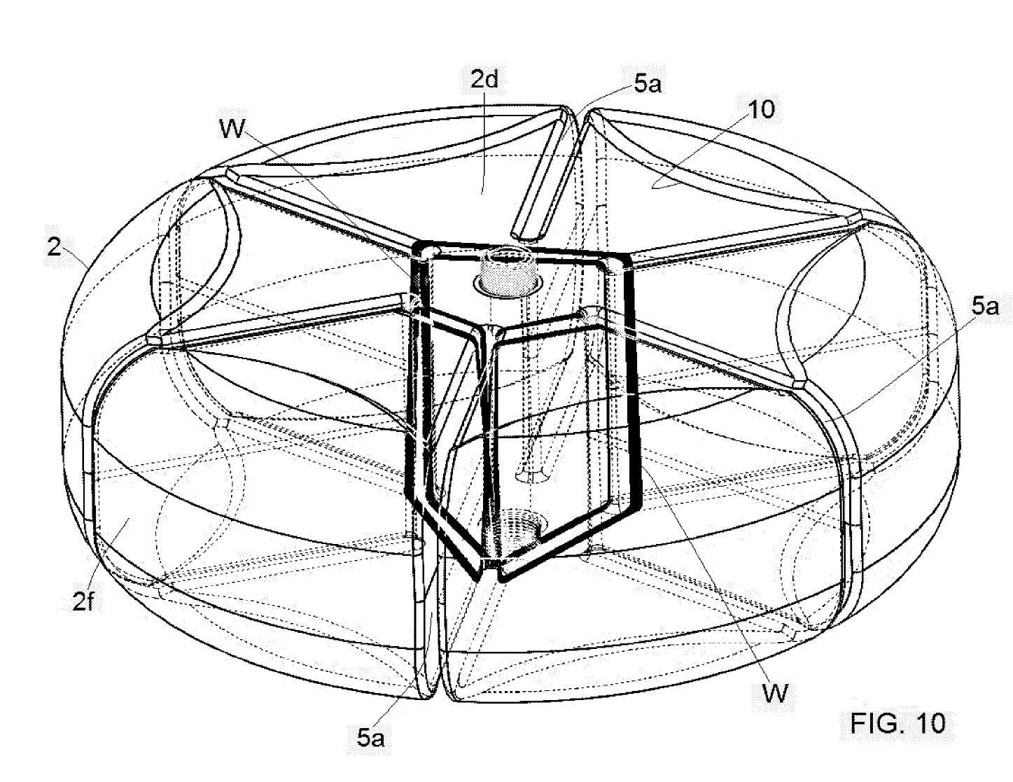

For such purpose, as is schematically illustrated in FIG. 10, a method for obtaining the reinforcement and framework structure comprising framework components 400 and reinforcement plate(s) 700a, 700b provides to wind continuous filaments of composite material in order to obtain both the framework components 400 and the reinforcement plate(s) 700a, 700b and subsequently cause the hardening/polymerization of the composite material or let the composite material to harden/polymerize. More particularly, according to such method, one or more filaments W are inserted and returned between the positioning seats 5a and/or between the positioning seats 5a and the edge 2f of the shell component 2, so as to wind such filament/s in such seats 5a and on the main faces 2d and 2e or on the respective impression 10, until the seats 5a have been filled to the desired amount and so as to cover the faces 2d and 2e or the respective impressions 10 to the desired amount. Subsequently, the composite material hardens, thereby obtaining the reinforcement and framework structure in a single piece or enbloc.

Even with such tank embodiment according to the present invention, a section for the engagement and insertion 5a of a respective connection portion 4a and 4d of the framework components 400 is provided; such section 5a is intended to allow the guided positioning or guided insertion in position of the framework components 400, if desired beam components, preferably transversally or intercepting the housing zone 3. Indeed, for such purpose the positioning seats make it possible to suitably arrange the filaments W and thus, at the end of the filament winding process, the framework components 400 and the reinforcement plates 700a, 700b.

In addition, a first step of filament winding could be conducted so as to partially fill the positioning seats 5a and partially cover the walls 2d, 2e, and then to harden the composite material or let such material to harden and subsequently conduct a second step of filament winding so as to complete the desired filling or engagement of the positioning seats 5a and of the walls 2d, 2e, until a reinforcement and framework structure is obtained in a single piece or substantially constituting a single body and comprising the hardened composite material filaments of both steps.

Of course, in place of the filament winding, the reinforcement and framework structure 400, 700a, 700b could be obtained by means of molding, if desired injection molding or via casting, even if such process would be more complex than the filament winding and would give rise to a weaker reinforcement and framework structure than the latter process.

In addition, the reinforcement plates 700a, 700b could constitute reinforcement sections or sectors and not cover or affect the entire extension of the faces 2d, 2e or of the respective impressions 10, but rather be resting or in abutment only against part thereof.

In addition, according to the variant just described, the external cover or coat layer 8 could be substantially achieved in a single piece with the reinforcement and framework structure 400, 700a and 700b, by means of one or more subsequent steps, e.g. by means of one or more steps of winding continuous filaments.

According to one variant, one tank according to the present invention could have a plurality of reinforcement and framework structures, each substantially made of a single piece and including two or more framework components 400, each inserted in a respective positioning seat or slit 5a and one or two sector-configured reinforcement plates 700a, 700b, for the connection of the framework components 400 and each intended to affect or cover (resting or in abutment) a respective portion of a main wall 2d, 2e or of an impression 10 thereof. Such considerations are also applied to the embodiments described with reference to FIGS. 1 to 7, which therefore could comprise multiple reinforcement and framework structures (not in a single piece) each including at least two beam components 4 as well as sector-like reinforcement plates 7a, 7b, 70a, 70b and intended to affect or cover only a part of the respective wall 2d, 2e or impression 10.

The reinforcement and framework structures in such case would be separated from each other or in any case would not be in a single piece, even if the same could be subsequently connected, for example by means of the external cover or coat layer 8.

For such purpose, a tank according to the present invention could also comprise a comprise a combination of the above-proposed solutions and more particularly a tank with framework components 400 and plates 7a, 7b, 700a, 700b; in such case, the plate(s) 7a, 7b would be arranged on one or a respective main face 2d, 2e of the shell component 2 or in an impression 10 thereof. Then the step of application would follow by means of filament winding or molding of the framework components 400 and plates 700a, 700b, covering both part of the shell component 2 and the plate(s) 7a, 7b and thus connecting the framework components 400 and the plate(s) 7a, 7b; thus a reinforcement and framework structure is obtained comprising framework components 400 and plates 7a, 7b, 700a, 700b.

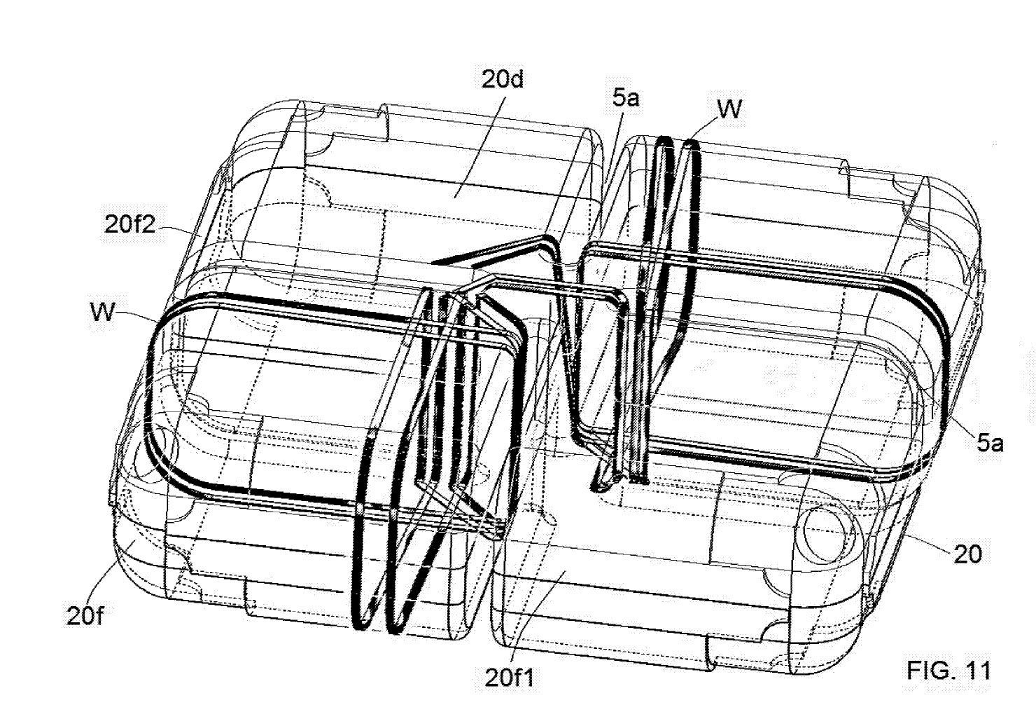

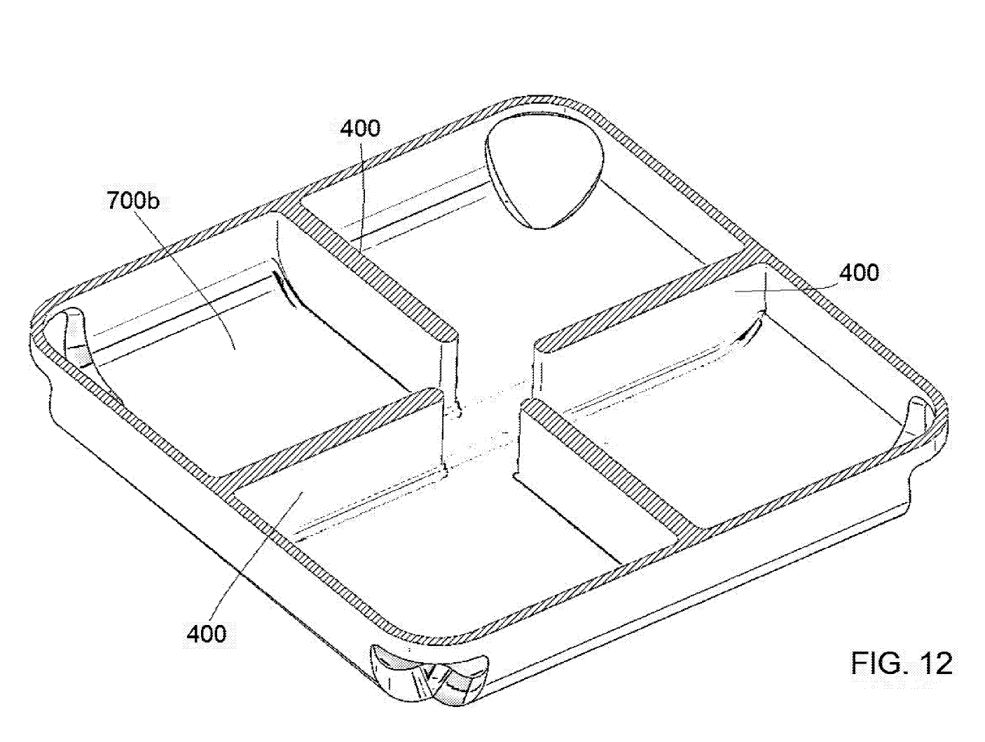

So far as the tank illustrated in FIGS. 11 and 12 is concerned, these illustrate a tank similar to that shown in FIGS. 4 to 7, but in which, in a manner entirely similar to that described now with reference to FIGS. 8 to 10, the framework components 400 and the reinforcement plates 700a, 700b are substantially made in a single piece, e.g. obtained by means of “filament winding” or winding of continuous filaments of composite material, i.e. by means of winding of continuous filaments on the shell component 2, 20.

Like that described above with reference to FIGS. 8 to 10, such tank could have a plurality of reinforcement and framework structures, each substantially made of a single piece or a combination of the above-proposed solutions and more particularly a tank with framework components 400 and plates 70a, 70b, 700a, 700b.

In addition, in such case, the reinforcement and framework structures 400, 700a, 700b could also comprise portions intended to cover the corners 20s of the shell component 20 and substantially corresponding to the protecting elements 11 of the embodiment illustrated in FIGS. 4 to 7.

As could be appreciated, unlike all of the abovementioned prior art documents and the tanks for pressurized gas proposed up to now, a more stable and stronger tank is illustrated herein.

For example, with regard to DE102012223676A1, this does not teach a tank with multiple positioning seats substantially arranged aligned or equally spaced and at least two framework components, each housed within one of such positioning seats. In addition, such prior document does not even teach a tank provided with reinforcement plates comparable to the reinforcement plates of a tank according to the present invention, and which, in combination with the framework components 4, 400, allow the optimal stiffening of the respective tank.

In addition, a tank according to the present invention is very simple to achieve, given that it is sufficient to bring the respective components into work position and then insert and engage respective portions or sections thereof; furthermore, it is very strong and does not have weakening points, due to the presence both of the plate components and, if desired, of the reinforcement plates.

In addition, as can be verified, a tank according to the present invention has a shape such to ensure a limited bulk and thus allow an optimal housing in a respective compartment, for example of a car.

Modifications and variants of the invention are possible within the protective scope defined by the claims.

1. A tank for containing a pressurized fluid comprising at least one shell component provided with an external, in use, surface and with an internal, in use, surface, said internal surface delimiting at least one housing zone for housing said fluid,
wherein said tank comprises at least two framework components and delimits at least one section for the engagement and insertion of or into a respective connection portion of said at least two framework components designed to allow for the guided positioning or the guided insertion in position of said at least two framework components, said at least one shell component delimiting at least two positioning seats or slits of said at least two framework components arranged angularly spaced or offset from one another,
wherein each framework component is inserted in a respective positioning seat and in that it comprises at least one reinforcement plate for connecting said at least two framework components.

2. The tank according to claim 1, wherein at least one positioning seat of said at least two positioning seats intercepts or extends through said at least one housing zone and in that said at least one section for the engagement and insertion allows for the guided positioning of at least one reinforcement component of said at least two framework components transversally or intercepting said at least one housing zone.

3. The tank according to claim 1, wherein it comprises at least two reinforcement plates for connecting respective ends of at least two framework components.

4. The tank according to claim 1, wherein at least one of said at least two positioning seats is fluidly sealed with respect to said at least one housing zone, so that said framework component arranged in said at least one positioning seat is not in contact with the pressurized fluid within the tank.

5. The tank according to claim 1, wherein said at least two framework components are made in a single piece with at least one reinforcement plate.

6. The tank according to claim 5, wherein said at least two framework components and at least one reinforcement plate are obtained by means of winding continuous filaments made of composite material.

7. The tank according to claim 1, wherein each of said at least two framework components comprises a beam framework component.

8. The tank according to claim 1, wherein said at least one section for the engagement and insertion can be accessed and engaged through a respective connection portion of a framework component starting from the exterior of said shell component.

9. The tank according to claim 1, wherein at least one connection portion of at least one of said at least two framework components engages with or inserts to size in a respective section for the engagement and insertion.

10. The tank according to claim 1, wherein said at least one shell component comprises at least one main wall and in that said at least one reinforcement plate is intended to be rested or abutted on said at least one main wall of said at least one shell component.

11. The tank according to claim 3, wherein said at least one shell component has an upper wall and a lower wall which are connected by means of an edge and in that said at least two reinforcement plates are in abutment and resting from the external one against said upper wall and the other against said lower wall.

12. The tank according to claim 11, wherein said section for the engagement and insertion comprises at least one protrusion or recessed portion provided on said reinforcement plate.

13. The tank according to claim 12, wherein said shell component comprises at least one protruding portion or hollow portion intended to engage with a respective protrusion or recessed portion of said at least one reinforcement plate.

14. The tank according to claim 1, wherein said at least one plate has at least one groove substantially aligned with a respective positioning seat, a framework component being inserted in said positioning seat and in said at least one groove of said at least one plate.

15. The tank according to claim 14, wherein said at least one groove is provided in said at least one protrusion or recessed portion.

16. The tank according to claim 1, wherein at least one framework component comprises a main wall extending transversally or intercepting said at least one housing zone as well as an end wall extending transversally with respect to said main wall and intended to slidably engage with a respective section for the engagement and insertion.

17. The tank according to claim 1, wherein said at least two positioning seats divide or separate said at least one housing zone in sectors.

18. The tank according to claim 1, wherein said shell component delimits the entire housing zone.

19. The tank according to claim 1, wherein said shell component is configured as a solid of rotation about an axis of symmetry (x-x) or substantially as a parallelepiped with two substantially main faces connected by means of an edge comprising a plurality of angularly offset sides.

20. The tank according to claim 19, wherein, if the shell component is shaped as a solid of rotation about an axis of symmetry (x-x), said at least two positioning seats of said framework component are extended radially with respect to said shell component, i.e. said positioning seats converge towards said axis of symmetry (x-x), whereas if said shell component is substantially configured as a parallelepiped, said at least two positioning seats are substantially parallel to one side of said edge of said shell component or converge towards a longitudinal axis of symmetry of said shell component.

21. The tank according to claim 19, wherein it comprises at least one protecting element including a substantially curved main intermediate section intended to wrap or cover a respective corner of said shell component from which wing-shaped sections extend, each wing-shaped section being intended to cover a section of a respective edge of the shell component.

22. The tank according to claim 7, wherein said connection portion of at least one beam component can be slidably engaged in a respective section for the engagement and insertion.

23. The tank according to claim 7, wherein said at least one beam component is arranged in an upright and self-supporting position, so as to stiffen or reinforce said tank without stressing other components of the tank itself.

24. The tank according to claim 1, wherein it comprises an outer covering or coating layer of said shell component and of said at least two framework components.

25. The tank according to claim 10, wherein it comprises a plurality of reinforcement and framework structures severed from one another, each reinforcement and framework structure including at least two framework components inserted in a respective positioning seat or slit and at least one reinforcement plate for the connection of said at least two framework components, said at least one reinforcement plate of each reinforcement and framework structure being intended to affect or cover a respective portion of a respective main wall.

26. A method for assembling a tank according to claim 1, wherein it comprises the following steps:
providing at least one shell component;
obtaining said at least two framework components and said at least one reinforcement plate so that said at least two framework components are each inserted in a respective positioning seat of said at least two positioning seats and are connected by means of said at least one reinforcement plate.

27. The method as claimed in claim 26, wherein said step of obtaining comprises the following steps:
providing at least two framework components; and
engaging at least one connection portion of said at least two framework components with a respective section for the engagement and insertion, thereby positioning in a guided manner said at least two framework components.

28. The method for assembling according to claim 27, wherein said connection portion is slidably mounted with or into said section for the engagement and insertion.

29. The method according to claim 27, wherein it comprises the following steps:
providing at least one reinforcement plate;
bringing said at least one reinforcement plate resting or abutting on a main wall of said at least one shell component; and
engaging at least one connection portion of said at least two framework components with a respective section for the engagement and insertion provided on said at least one reinforcement plate.

30. The method as claimed in claim 26, wherein said step of obtaining comprises a step of making said at least two framework components substantially in a single piece with said at least one reinforcement plate.

31. The method as claimed in claim 30, wherein said step of obtaining comprises a step of winding continuous filaments made of a composite material for obtaining both said at least two framework components and at least one reinforcement plate.

32. The method as claimed in claim 26, wherein said step of obtaining comprises a plurality of steps each for obtaining a respective reinforcement and framework structure including at least two framework components inserted in a respective positioning seat or slit and at least one sector-shaped reinforcement plate for the connection of said at least two framework components, each reinforcement plate of each reinforcement and framework structure being intended to affect or cover a respective portion of a main wall of said at least one shell component.
